(19) United States
(12) Patent Application Publication
(10) Pub. No.: US 2010/0085731 A1
(43) Pub. Date: Apr. 8, 2010

(54) Light-emitting warning device of a water quality monitoring device

(76) Inventor: Mei-Lan Chen, Yongkang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/285,541

(22) Filed: Oct. 8, 2008

(51) Int. Cl. F21V 33/00

(52) U.S. Cl. 362/96

(57) ABSTRACT

A water quality monitoring device includes a light-emitting warning device joined on a water outlet of a water filtering device; the light-emitting warning device includes a base member, a light-reflecting plate on an upper side of the base member, a covering on an upper side of the light-reflecting plate, a light-emitting mechanism positioned between the light-reflecting plate and the covering, and a cover; the cover is a translucent membrane made of a pervious-to-light material and treated with a sputtering process, and it can guide light in such a manner that light can be uniformly emitted, and is like a metallic material in a normal condition; the covering has a light-reflecting silver strip on its circumferential side, and has light-scattering granules all over it; light emitted from the light-emitting mechanism will be reflected by the light-reflecting plate, and next scattered by the granules and the silver strip, and finally uniformly emitted.

### BACKGROUND OF THE INVENTION

1. Field of the invention

The present invention relates to a light-emitting warning device of a water quality monitoring device, more particularly one, which is connected to a water quality examining and measuring device installed in a water filtering device, and which is equipped with a cover capable of making light uniformly emitted.

2. Brief Description of the Prior Art

The environment has much more exhaust, wastewater, garbage, and noise now than it did decades ago with fast progress in science and technology and rapid development of commerce and industry. Furthermore, garbage would be dumped, and wastewater and exhaust air discharged from factories by those persons who aren't public-spirited before they are properly processed. Consequently, the air, rivers, lakes and reservoirs are polluted, and people have to use various kinds of water filtering devices to purify tap water before they drink it.

Filters of water filtering devices usually have labels stuck thereon, which show the expiry date of the filters; thus, the user can notice the expiry date, and change filters at an appropriate time. However, the labels aren't easily noticeable, and some people could forget to check the expiry date on the labels, and in turn the filters wouldn't be replaced with new ones after they expire. Moreover, a filter should be replaced with a new one certain length of time before the expiry date if the filter is used to filter large amount of water regularly.

To overcome the above-mentioned problem, the industry developed a warning device of a water quality monitoring device; the warning device is joined on a lower end of a faucet of a drinking fountain, and electrically connected to a water quality examining and measuring device of the drinking fountain. The warning device consists of a base, a light-emitting warning mechanism, and an upper cover joined on the base; the base has a holding space, in which the light-emitting warning mechanism is held; the upper cover is made of a transparent material, and has many tiny step-shaped portions thereon, which are pervious to light, and can make light emitted from the light-emitting warning mechanism travel in different directions. However, the upper cover doesn't have very high light-perviousness, and can't make light of the light-emitting warning mechanism uniformly emitted in all directions because it is only made of a transparent material. Consequently, light of the warning device can't be easily noticed by the users.

Therefore, it is a main object of the present invention to provide an improvement on a light-emitting warning device of a water quality monitoring device to overcome the above problems.

### SUMMARY OF THE INVENTION

A light-emitting warning device in accordance with an embodiment of the present invention includes a base member, a light-reflecting plate on an upper side of the base member, a covering on an upper side of the light-reflecting plate, a light-emitting mechanism positioned between the light-reflecting plate and the covering, and a cover positioned over the covering. The cover is a translucent membrane made of a pervious-to-light material and treated with a sputtering process, and it can guide light in such a manner that light can be uniformly emitted, and is like a metallic material in a normal condition. The covering has a light-reflecting silver strip on its circumferential side, and has many light-scattering granules all over it the light-emitting mechanism will start emitting light as soon as a water quality examining and measuring device finds out that water quality is below the standard; light emitted from the light-emitting mechanism can be reflected by the light-reflecting plate, and next scattered by means of the light-scattering granules and the light-reflecting silver strip, and finally guided by the cover so as to be uniformly emitted.

### BRIEF DESCRIPTION OF THE DRAWINGS

The present invention will be better understood by referring to the accompanying drawings, wherein:

FIG. 1 is an exploded perspective view of the light-emitting warning device in the present invention,

FIG. 2 is a partially exploded perspective view of the light-emitting warning device joined to a water outlet of a water filter, and

FIG. 3 is a perspective view of the present warning device.

### DETAILED DESCRIPTION OF THE PREFERRED EMBODIMENTS

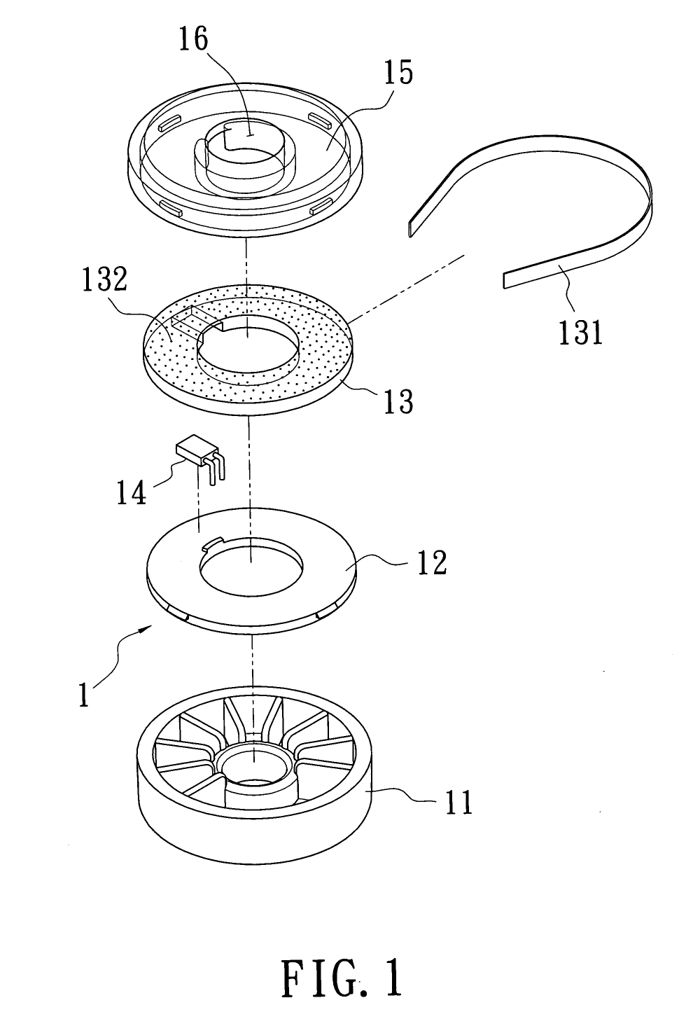

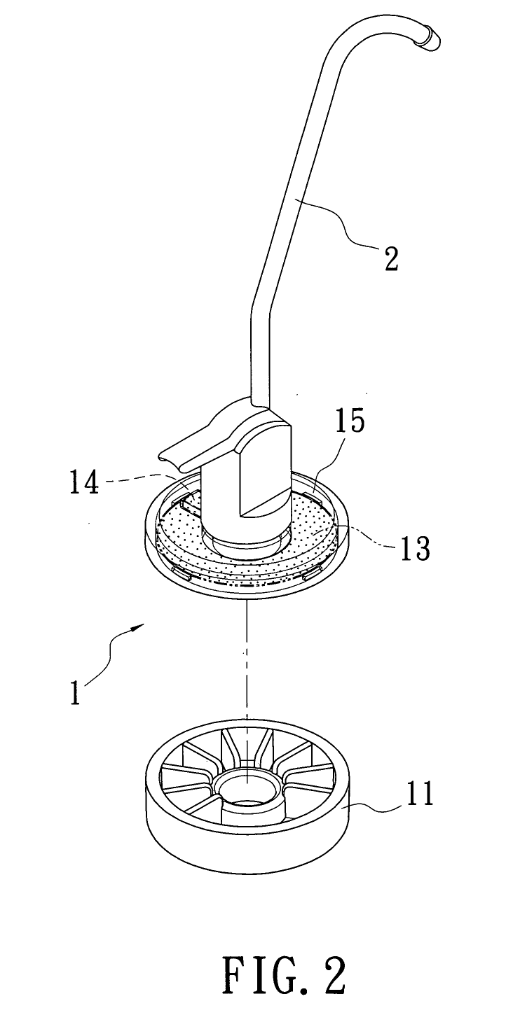

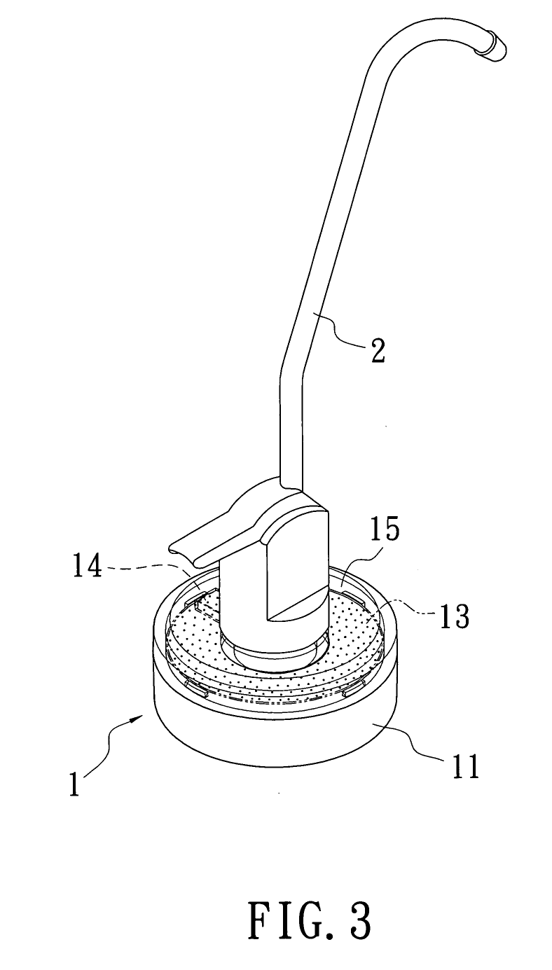

Shown in FIG. 1 to FIG. 3 is a preferred embodiment 1 of a light-emitting warning device of a water quality monitoring device of the present invention, which is joined on a water outlet 2 of a water filtering device, and connected to a water quality examining and measuring device (not shown). The light-emitting warning device 1 consists of a base member 11, a light-reflecting plate 12, a covering 13, a light-emitting mechanism 14, and a cover 15.

The light-reflecting plate 12 is positioned on an upper side of the base member 11. The covering 13 is positioned on an upper side of the light-reflecting plate 12. The light-emitting mechanism 14 is positioned between the light-reflecting plate 12 and the covering 13. The cover 15 is positioned over an outer side of the covering 13; the cover 15 is a translucent membrane, which is made of a pervious-to-light material, and has been treated with a sputtering process; the cover 15 can guide light in such a manner that light can be uniformly emitted with the help of the cover 15; the cover 15 like a metallic material in a normal condition. Moreover, the covering 13 has a light-reflecting silver strip 131 positioned on a circumferential side thereof. And, the covering 13 has many light-scattering granules 132 formed all over it. The light-emitting warning device 1 further has a joining hole 16, which is joined to the water outlet 2 of the water filtering device.

Therefore, the light-emitting mechanism 14 of the light-emitting warning device 1 will start emitting light as soon as the water quality examining and measuring device finds out that water quality of the product of the water filtering device is below the predetermined standard; light emitted from the light-emitting mechanism 14 will be reflected by the light-reflecting plate 12, and next scattered by means of the light-scattering granules 132 and the light-reflecting silver strip 131 of the covering 13, and finally guided so as to be uniformly emitted by means of the cover 15. The user should change filters for the water filtering device to improve the water quality after he sees the warning device 1 of the present invention emitting light.

It can be seen that the light-emitting warning device of the present invention is more practical than the prior art for the following reasons: the light-emitting warning device includes a base member, a light-reflecting plate on an upper side of the base member, a covering on an upper side of the light-reflecting plate, a light-emitting mechanism positioned between the light-reflecting plate and the covering, and a cover positioned over an outer side of the covering, which is a translucent membrane made of a pervious-to-light material and treated with a sputtering process, and which can guide light in such a manner that light can be uniformly emitted with the help of the cover, and is like a metallic material in a normal condition; the covering has a light-reflecting silver strip positioned on a circumferential side, and has many light-scattering granules formed all over it; light emitted from the light-emitting mechanism can be reflected by the light-reflecting plate, and next scattered by means of the light-scattering granules and the light-reflecting silver strip of the covering, and finally guided by means of the cover so as to be uniformly emitted to warn the users.

What is claimed is:

1. A light-emitting warning device of a water quality monitoring device,
the light-emitting warning device being joined on a water outlet of a water filtering device; the light-emitting warning device comprising:
(a) a base member;
(b) a light-reflecting plate positioned on an upper side of the base member;
(c) a covering positioned on an upper side of the light-reflecting plate;
(d) a light-emitting mechanism positioned between the light-reflecting plate and the covering; and
(e) a cover positioned over an outer side of the covering; the cover being a translucent membrane, which is made of a pervious-to-light material, and has been treated with a sputtering process; the cover being capable of guiding light in such a manner that light is uniformly emitted with a help of the cover; the cover being like a metallic material in a normal condition.

2. The light-emitting warning device of a water quality monitoring device as claimed in claim 1, wherein the covering has a plurality of light-scattering granules formed all over it.

3. The light-emitting warning device of a water quality monitoring device as claimed in claim 1, wherein the covering has a light-reflecting silver strip positioned on a circumferential side thereof.
